(19) United States
(12) Patent Application Publication
(10) Pub. No.: US 2026/0366108 A1
(43) Pub. Date: Nov. 19, 2026

(54) NON-ORIENTED ELECTRICAL STEEL SHEET AND METHOD FOR MANUFACTURING SAME

(71) Applicant: POSCO Co., Ltd, Pohang-si, Gyeongsangbuk-do (KR)

(72) Inventors: Jae-Hoon KIM, Gwangyang-si, Jeollanam-do (KR); Sang-Woo LEE, Pohang-si, Gyeongsangbuk-do (KR); Yun-Su KIM, Pohang-si, Gyeongsangbuk-do (KR)

(73) Assignee: POSCO Co., Ltd, Pohang-si, Gyeongsangbuk-do (KR)

(21) Appl. No.: 19/127,920

(22) PCT Filed: Dec. 13, 2023
(86) PCT No.: PCT/KR2023/020587

§ 371 Date: May 7, 2025

(30) Foreign Application Priority Data
Dec. 21, 2022 (KR) 10-2022-0181026

(51) Int. Cl. C22C 38/02; C21D 8/1216; C21D 8/1244; C21D 9/46; C22C 38/00; C22C 38/04; C22C 38/06; C22C 38/16; H01F 1/147

(52) U.S. Cl. CPC C22C 38/02; C21D 8/1222; C21D 8/1233; C21D 8/1261; C21D 9/46; C22C 38/002; C22C 38/008; C22C 38/04; C22C 38/06; C22C 38/16; H01F 1/14775; H01F 1/14791; C22C 2202/02

(57) ABSTRACT

The present invention relates to a non-oriented electrical steel sheet and a method for manufacturing same, and more specifically to a non-oriented electrical steel sheet preferably usable as an iron core of a motor, and a method for manufacturing same. One aspect of the present invention is for providing a non-oriented electrical steel sheet having low high-frequency iron loss, and a method for manufacturing same.

### TECHNICAL FIELD

The present disclosure relates to a non-oriented electrical steel sheet and a method for manufacturing the same, and more particularly, to a non-oriented electrical steel sheet which may preferably be used as an iron core of a motor, or the like, and a method for manufacturing the same.

### BACKGROUND ART

Recently, as disasters due to climate change have increased, countries around the world have announced carbon neutrality roadmaps for 2050. The total carbon emissions in 2020 reached 39 billion tons, and the amount emitted by internal combustion engines is 9.4 billion tons, accounting for 24%. Accordingly, there has been a great demand to achieve carbon neutrality in this field through electrification of internal combustion engines. To this end, electrification has been rapidly implemented in the mobility field, starting with electric vehicles. The characteristics required for a driving motor in new mobility may be to increase a driving distance and to increase a maximum speed, which may be directly related to a low iron loss characteristic of an electrical steel sheet.

Generally, in order to improve recrystallization texture, a method of suppressing formation of orientations inferior to magnetism using grain boundary segregation elements. However, by using a large amount of segregation elements, brittleness of steel may increase, such that rolling productivity may deteriorate.

### DETAILED DESCRIPTION OF PRESENT DISCLOSURE

### Technical Problems to Solve

An aspect in the present disclosure is to provide a non-oriented electrical steel sheet having low high frequency iron loss, and a method for manufacturing the same.

### Solution to Problem

According to an embodiment of the present disclosure, a non-oriented electrical steel sheet includes, by weight %, Si: 3.3 to 4.3%, Al: 0.8 to 1.7%, Mn: 0.3 to 2.0%, Cu: 0.03 to 0.5%, Sn: 0.01 to 0.1%, S: 0.002 to 0.01%, and a balance of Fe and inevitable impurities, wherein relational expression 1 is satisfied, and wherein texture (112)[1-31]/texture (112)[1-10] strength ratio is 2.0 or more:

$$0.02 \leq Sn \times S \times 100 / Cu \leq 0.75 . \qquad [ Relational expression 1 ]$$

The non-oriented electrical steel sheet may further include one or more of C: 0.005% or less, N: 0.005% or less, Ti: 0.005% or less, Nb: 0.005% or less and V: 0.005% or less.

The non-oriented electrical steel sheet may further include one or more of P: 0.1% or less, Cr: 0.01 to 0.5%, Sb: 0.1% or less, Ni: 0.05% or less and Zn: 0.01% or less.

The non-oriented electrical steel sheet may further include one or more of Mo: 0.03% or less, B: 0.0050% or less, Ca: 0.005% or less and Mg: 0.005% or less.

The non-oriented electrical steel sheet may further include 0.20% or less (excluding 0%) of one or more of Bi, Pb, Ge and As individually or in combination.

A strength of texture (112)[1-31] of the non-oriented electrical steel sheet may be 2.5 or more and a strength of texture (112)[1-10] is 0.9 or less.

The non-oriented electrical steel sheet may have a resistivity of 55 μΩcm or more.

The non-oriented electrical steel sheet may have iron loss (W10/400) of 12.2 W/Kg or less.

The non-oriented electrical steel sheet may have a magnetic flux density (B50) of 1.66 Tesla or more.

According to another embodiment of the present disclosure, a method for manufacturing a non-oriented electrical steel sheet includes heating a slab including, by weight %, Si: 3.3 to 4.3%, Al: 0.8 to 1.7%, Mn: 0.3 to 2.0%, Cu: 0.03 to 0.5%, Sn: 0.01 to 0.1%, S: 0.002 to 0.01%, and a balance of Fe and inevitable impurities, and satisfying relational expression 1 as below at 1100 to 1250 °C; finishing hot-rolling the heated slab at 800 to 1000 °C and obtaining a hot-rolled sheet; cold-rolling the hot-rolled sheet at a reduction ratio of 70 to 95% and obtaining a cold-rolled sheet; final annealing for cracking the cold-rolled sheet at 950 to 1020 °C for 30 to 60 seconds, wherein, in the final annealing, entrance tension of an annealing furnace is 0.5 to 0.5 to 1.0 kgf/mm², and a holding time in a 600 to 750 °C section during heating to a cracking temperature is controlled to 24 seconds or less:

0.02≤Sn×S×100/Cu≤0.75 [Relational expression 1]

The slab may further include one or more of C: 0.005% or less, N: 0.005% or less, Ti: 0.005% or less, Nb: 0.005% or less and V: 0.005% or less.

The slab may further include one or more of P: 0.1% or less, Cr: 0.01 to 0.5%, Sb: 0.1% or less, Ni: 0.05% or less and Zn: 0.01% or less.

The slab may further include one or more of Mo: 0.03% or less, B: 0.0050% or less, Ca: 0.005% or less and Mg: 0.005% or less.

The slab may further include 0.20% or less (excluding 0%) of one or more of Bi, Pb, Ge and As individually or in combination.

The method may further include hot-rolled sheet annealing the hot-rolled sheet at 850 to 1150 °C after the obtaining the hot-rolled sheet.

The cold-rolling may be performed once or twice.

### Advantageous Effects of Invention

According to an aspect of the present disclosure, a non-oriented electrical steel sheet having low high frequency iron loss and a method for manufacturing the same may be provided.

### BEST MODE FOR INVENTION

It was found out that, to improve iron loss of a non-oriented electrical steel sheet, resistivity may be increased using Si, Al, and Mn, which are elements increasing resistivity, and by using Sn, S, and Cu, which are elements controlling segregation, and also appropriately controlling the conditions during the final annealing, a region in which the texture is improved may be derived, and a non-oriented electrical steel sheet having excellent magnetism may be manufactured, and the present invention was completed.

Hereinafter, anon-oriented electrical steel sheet according to an embodiment of the present invention may be described. First, an alloy composition may be described. The content of the alloy composition described below may be indicated in weight % unless otherwise indicated.

### Si: 3.3 to 4.3%

Si may increase resistivity of a material and may reduce iron loss. When the Si content is less than 3.3%, the effect of addressing high frequency iron loss may be minimal. When the Si content exceeds 4.3%, productivity and the ductility may be deteriorated due to an increase in hardness. Accordingly, the Si content may have a range of 3.3 to 4.3%. A lower limit of the Si content may be 3.35% preferably, and may more preferably be 3.40%. An upper limit of the Si content may preferably be 4.25%, and may more preferably be 4.20%.

### Al: 0.8 to 1.7%

Al may increase resistivity of a material and may lower iron loss. When the Al content is less than 0.8%, there may be no effect of reducing high frequency iron loss, and nitride may be formed finely, which may deteriorate magnetism. When the Al content exceeds 1.7%, properties of mold flux may change during a continuous casting process, which may significantly reduce productivity. Accordingly, the Al content may have a range of 0.8 to 1.7%. A lower limit of the Al content may more preferably be 0.85%, and may even more preferably be 0.90%. An upper limit of the Al content may more preferably be 1.65%, and may even more preferably be 1.60%.

### Mn: 0.3 to 2.0%

Mn may improve iron loss by increasing resistivity of the material and may form sulfides. When the Mn content is less than 0.3%, MnS may be finely precipitated, which may deteriorate magnetism. When the content of the Mn exceeds 2.0%, the formation of [111] texture, which is unfavorable for magnetism, may be promoted, which may rapidly reduce magnetic flux density. Accordingly, the content of the Mn may preferably range from 0.3 to 2.0%. A lower limit of the Mn content may more preferably be 0.35%, and may be 0.40%. An upper limit of the Mn content may be 1.95%, and may even more preferably be 1.90%.

### Cu: 0.03 to 0.5%

Cu may form sulfides with Mn and may precipitate together with segregation elements S and Sn, thereby hindering segregation. When the Cu content is less than 0.03%, CuMnS may be finely precipitated, which may deteriorate magnetism, and may form fine precipitates with S and Sn, thereby preventing segregation. When the Cu content exceeds 0.5%, high-temperature brittleness may occur, which may cause cracks during continuous casting or hot-rolling. Accordingly, the Cu content may be in the range of 0.03 to 0.5% preferably. A lower limit of the Cu content may more preferably be 0.04%, and even more preferably 0.05%. An upper limit of the Cu content may more preferably be 0.45%, and even more preferably 0.40%.

### Sn: 0.01 to 0.1%

Sn may segregate or precipitate at grain boundaries when annealing conditions are appropriately controlled. Also, Sn may form an intermetallic compound by complex precipitation with Cu, or may be complex precipitated as a sulfide. When the Sn content is less than 0.01%, it may be difficult to sufficiently obtain grain boundary segregation or precipitation effect. When the Sn content exceeds 0.1%, Sn may precipitate as an intermetallic compound or sulfide and may deteriorate magnetism. Accordingly, the Sn content may have a range of 0.01 to 0.10% preferably. A lower limit of the Sn content may more preferably be 0.02%, and may even more preferably be 0.03%. An upper limit of the Sn content may more preferably be 0.09%, and may even more preferably be 0.08%.

### S: 0.002 to 0.01%

S may segregate or precipitate at grain boundaries when annealing conditions are appropriately controlled. Also, S may form an intermetallic compound by complex precipitation with Cu, or may be complex precipitated as sulfides. When the S content is less than 0.002%, it may be difficult to sufficiently obtain the grain boundary segregation or precipitation effect. When the S content exceeds 0.01%, S may be precipitated as an intermetallic compound or sulfides, which may deteriorate magnetism. Accordingly, the S content may have a range of 0.002 to 0.01%% preferably. The S content may more preferably be 0.0025%, and may even more preferably be 0.0030%, and may most preferably be 0.0035%. An upper limit of the S content may more preferably be 0.009%, and may even more preferably be 0.008%.

A remainder of the present disclosure is iron (Fe). However, in a general manufacturing process, inevitable impurities may be inevitably added from raw materials or an ambient environment, and thus, impurities may not be excluded. A person skilled in the art of a general manufacturing process may be aware of the impurities, and thus, the descriptions of the impurities may not be provided in the present disclosure.

The non-oriented cold-rolled steel sheet of the present invention may further include one or more of C: 0.005% or less, N: 0.005% or less, Ti: 0.005% or less, Nb: 0.005% or less, and V: 0.005% or less.

### C: 0.005% or Less

C may react with N, Ti, Nb, V, or the like, and may form fine carbides, which may hinder grain growth and magnetic domain movement. An upper limit thereof may be limited to 0.005%. More specifically, the content of C may be 0.0001 to 0.005%. More specifically, the content of C may be 0.0005 to 0.003%.

### N: 0.005% or Less

N may combine with Ti, Nb, V, or the like, and may form nitrides, which may hinder grain growth, and thus, an upper limit thereof may be limited to 0.005%. More specifically, the content of N may be 0.0001 to 0.005%. More specifically, the content of N may be 0.0005 to 0.003%.

### Ti: 0.005% or Less

Since Ti may combine with C, N, O, or the like, and may form fine nitrides or oxides, such that magnetic domain movement may be hindered, and thus, an upper limit may be limited to 0.005%. More specifically, the content of Ti may be 0.0001 to 0.005%. More specifically, the content of Ti may be 0.0005 to 0.003%.

### Nb: 0.005% or Less

Nb may combine with C, N, or the like, and may form fine nitrides such that magnetic domain movement may be hindered, and thus, an upper limit may be limited to 0.005%. More specifically, the content of Nb may be 0.0001 to 0.005%. More specifically, the content of Nb may be 0.0005 to 0.003%.

### V: 0.005% or Less

V may combine with C, N, or the like and may form fine nitrides, such that magnetic domain movement may be hindered, and thus, an upper limit may be limited to 0.005%. More specifically, the content of V may be 0.0001 to 0.005%. More specifically, the content of V may be 0.0005 to 0.003%.

The non-oriented cold-rolled steel sheet of the present invention may further include one or more of P: 0.1% or less, Cr: 0.01 to 0.5%, Sb: 0.1% or less, Ni: 0.05% or less and Zn: 0.01% or less.

### P: 0.1% or Less

P may be a grain boundary segregation element which may delay recrystallization and may deteriorate strength uniformity in the rolling direction and the vertical rolling direction, and thus, an upper limit may be limited to 0.10%. More specifically, the P content may be 0.0001 to 0.1%. More specifically, the P content may be 0.001 to 0.05%.

### Cr: 0.01 to 0.5%

Cr may improve iron loss by increasing resistivity. When the Cr content is less than 0.01%, the resistivity improvement effect may not be sufficient. When the Cr content exceeds 0.5%, magnetic flux density may decrease. More specifically, the Cr content may be 0.02 to 0.3%.

### Sb: 0.1% or Less

Sb may segregate at grain boundaries, and may be added to suppress diffusion of nitrogen through grain boundaries, to suppress the {111}texture (texture) which is detrimental to magnetism, and to increase the {100}texture advantageous, thereby improving magnetic properties. When the content of Sb exceeds 0.1%, it may hinder grain growth, may lower magnetism, and cause poor rolling properties. More specifically, the content of Sb may be 0.001 to 0.1%. More specifically, the content of Sb may be 0.005 to 0.08%.

### Ni: 0.05% or Less

Ni may react with impurity elements and may form fine sulfides, carbides, and nitrides, which have a detrimental effect on magnetism, and thus, an upper limit thereof may be limited to 0.05%. More specifically, the content of Ni may be 0.0001 to 0.050%. More specifically, the content of Ni may be 0.001 to 0.030%.

### Zn: 0.01% or Less

Zn may act as an impurity and may deteriorate magnetism, and thus, an upper limit may be limited to 0.01%. More specifically, the content of Zn may be 0.0001 to 0.01%. More specifically, the content of Zn may be 0.001 to 0.008%.

The non-oriented cold-rolled steel sheet of the present invention may further include one or more of Mo: 0.03% or less, B: 0.0050% or less, Ca: 0.005% or less and Mg: 0.005% or less.

These may react with C, S, N, or the like, inevitably included, and may form fine carbides, nitrides or sulfides, which may adversely affect magnetism, and thus, an upper limit thereof may be limited as described above.

The non-oriented cold-rolled steel sheet of the present invention may further include 0.20% or less (excluding 0%) of one or more of Bi, Pb, Ge and As individually or in combination.

When the above-mentioned elements are additionally added, the elements may segregate at a grain boundary, and stress concentration may be relieved at the grain boundary during cold-rolling, and recrystallization of <111>//ND orientation grains may be inhibited in the subsequent recrystallization annealing process, thereby improving magnetic flux density. When the elements are added appropriately, the above-mentioned effect may be additionally obtained, but when the elements are included excessively, a large amount of segregation may occur, which may inhibit grain growth and may deteriorate magnetic flux density and iron loss. More specifically, one or more of Bi, Pb, Ge and As may be included in an amount of 0.0001 to 0.20% individually or in combination. More specifically, one or more of Bi, Pb, Ge and As may be included in an amount of 0.001 to 0.10% individually or in combination.

It may be preferable that the non-oriented cold-rolled steel sheet of the present invention satisfies the aforementioned alloy composition and relational expression 1 as below.

$$0.02 \leq Sn \times S \times 100 / Cu \leq 0.75 \qquad [ Relational expression 1 ]$$

Sn, S, and Cu may control segregation, and when the final annealing conditions are appropriately controlled, the texture (112)[1-31]/texture (112)[1-10] strength ratio of the texture may be controlled. When the value of the Sn×S×100/Cu is less than 0.02, the Cu content may be high as compared to Sn and S, such that segregation may not easily occur. When the value of Sn×S×100/Cu exceeds 0.75, segregation may be excessively developed, which may deteriorate magnetism. A lower limit of the Sn×S×100/Cu value may more preferably be 0.025, and may even more preferably be 0.03. An upper limit of the Sn×S×100/Cu value may more preferably be 0.70, and may even more preferably be 0.65.

Preferably, as for the non-oriented electrical steel sheet of the present invention, the texture (112)[1-31]/texture (112)[1-10] strength ratio may be 2.0 or more. Even on the same (112) plane, when strength of the texture corresponding to the [1-31] direction is higher than that of the [1-10] direction, magnetism may be improved. When the texture (112)[1-31]/texture (112)[1-10] strength ratio is less than 2.0, the magnetic improvement effect may not be sufficiently obtained. The texture (112)[1-31]/texture (112)[1-10] strength ratio may preferably be 2.2 or more, may preferably be 2.4 or more, and most preferably 2.6 or more. In the present invention, when the texture (112)[1-31]/texture (112)[1-10] strength ratio increases, it may be advantageous, and thus, there may be no particular limitation on an upper limit thereof. However, an upper limit of the texture (112)[1-31]/texture (112)[1-10] strength ratio may be, for example, 6.0.

As for the non-oriented electrical steel sheet, a strength of texture (112)[1-31] may be 2.5 or more, and a strength of texture (112)[1-10] may be 0.9 or less, and by satisfying these conditions, magnetism may be improved. The strength of the texture (112)[1-31] may preferably be 2.7 or more, more preferably 2.9 or more, and most preferably 3.1 or more. The strength of the texture (112)[1-10] may preferably be 0.7 or less, and more preferably 0.5 or less. In the present invention, when the strength of the texture (112)[1-31] increases, it may be advantageous, and thus, there may be no particular limitation on an upper limit thereof. However, an upper limit of strength of the texture (112)[1-31] may be, for example, 6.0. Also, when the strength of the texture (112)[1-10] decreased, it may be advantageous, and thus, there may be no particular limitation on a lower limit thereof. However, a lower limit of the strength of the texture (112)[1-10] may be, for example, 0.2.

As described above, the non-oriented electrical steel sheet of the present invention provided may have a resistivity of 55 μΩcm or more, an iron loss (W10/400) of 12.2 W/Kg or less, and a magnetic flux density (B50) of 1.66 Tesla or more. In the present invention, when the lower resistivity and iron loss (W10/400) decrease, it may be advantageous, and thus, there may be no particular limitation on a lower limit thereof. The iron loss (Wi0/400) and magnetic flux density (B50) may be based on a thickness of 0.25 mm of the steel sheet.

Hereinafter, a method for manufacturing a non-oriented electrical steel sheet according to an embodiment of the present invention may be described.

First, a slab satisfying the aforementioned alloy composition and relational expression 1 may be heated at 1100 to 1250 °C. When the slab heating temperature is less than 1100 °C, the holding time may be too long for the entire slab to have the same temperature, which may reduce productivity. When the slab heating temperature exceeds 1250 °C, the inclusions generated during casting may be re-dissolved and may be finely precipitated during the hot rolling process, which may deteriorate magnetism. Accordingly, the slab heating temperature may have a range of 1100 to 1250 °C preferably. A lower limit of the slab heating temperature may preferably be 1110 °C, more preferably 1120 °C, and most preferably 1130 °C. An upper limit of the slab heating temperature may more preferably be 1240 °C, even more preferably 1230 °C, and most preferably 1220 °C.

Thereafter, the heated slab may be finishing hot-rolled at 800 to 1000 °C and a hot-rolled sheet may be obtained. When the finishing hot-rolling temperature is lower than 800 °C, the temperature during hot-rolling may be excessively low, such that it may be impossible to roll to the desired thickness. When the finishing hot-rolling temperature exceeds 1000 °C, surface oxidation control and shape control may be difficult. A lower limit of the finishing hot-rolling temperature may be 810 °C preferably, more preferably 820 °C, and most preferably 830 °C. An upper limit of the finishing hot-rolling temperature may preferably be 990 °C, more preferably 980 °C, and most preferably 970 °C.

After the obtaining the hot-rolled sheet, the hot-rolled sheet may be hot-rolled sheet annealed at 850 to 1150 °C. By the hot-rolled sheet annealing, crystal orientation which may be favorable to magnetism may increase. When the temperature of the hot-rolled sheet annealing is lower than 850 °C, grains may not grow or may grow finely, which may reduce the effect of increasing magnetic flux density. When the temperature of the hot-rolled sheet annealing exceeds 1150 °C, magnetic properties may be deteriorated, and rolling workability may deteriorate due to deformation of the plate shape. Accordingly, the temperature of the hot-rolled sheet annealing may range from 850 to 1150 °C. A lower limit of the temperature of the hot-rolled sheet annealing may be 870 °C preferably, more preferably 890 °C, and most preferably 910 °C. An upper limit of the temperature of the hot-rolled sheet annealing may preferably be 1140 °C, and more preferably 1130 °C. Meanwhile, the hot-rolled sheet annealing may not be performed.

Thereafter, the hot-rolled sheet may be cold-rolled at a reduction ratio of 70 to 95% and a cold-rolled sheet may be obtained. When the cold-rolling reduction ratio is less than 70%, the deformation structure may be non-uniform, which magnetic deviation of the final product may increase. When the cold-rolling reduction ratio exceeds 95%, a texture unfavorable to magnetism may develop, which may deteriorate magnetism of the final product. Accordingly, the cold-rolling reduction ratio may have a range of 70 to 95% preferably. A lower limit of the cold-rolling reduction ratio may preferably be 72%, more preferably 74%, and even more preferably 76%. An upper limit of the cold-rolling reduction ratio may more preferably be 93%, even more preferably 91%, and most preferably 89%. The cold-rolling may be performed once or twice to obtain the target thickness.

Thereafter, final annealing of the cold-rolled sheet may be performed at 950 to 1020 °C for 30 to 60 seconds to crack. When the cracking temperature is lower than 950 °C, an appropriate level of grain growth may not occur, and thus, the magnetic enhancement effect may not be obtained. When the cracking temperature exceeds 1020 °C, defects such as microdents on the surface may increase, and grain growth may increase, high frequency iron loss may become worse. A lower limit of the cracking temperature may preferably be 955 °C, more preferably 960 °C, and most preferably 965 °C. An upper limit of the cracking temperature may more preferably be 1015 °C, even more preferably 1010 °C, and most preferably 1005 °C. When the cracking time is less than 30 seconds, the grain size may not grow sufficiently, which may deteriorate magnetism. When the cracking time exceeds 60 seconds, the grain may become excessively large. A lower limit of the cracking time may preferably be 32 seconds, more preferably 34 seconds, and most preferably 36 seconds. An upper limit of the cracking time may more preferably be 59 seconds, even more preferably 58 seconds, and most preferably 57 seconds.

During the final annealing, the annealing furnace entrance tension may be 0.5 to 1.0 kgf/mm², and it may be preferable to control the holding time in the 600 to 750 °C section during heating to the cracking temperature to 24 seconds or less. When the tension is appropriately applied at the annealing furnace entrance, grain boundary segregation may be promoted, which may improve magnetism. When the annealing furnace entrance tension is less than 0.5 kgf/mm², it may be difficult to control plate drift during continuous annealing. When the annealing furnace entrance tension exceeds 1.0 kgf/mm², the formation of a texture unfavorable to magnetism may be promoted. A lower limit of the annealing furnace entrance tension may more preferably be 0.55 kgf/mm², even more preferably 0.6 kgf/mm², and most preferably 0.65 kgf/mm². An upper limit of the annealing furnace entrance tension may more preferably be 0.95 kgf/mm², even more preferably 0.90 kgf/mm², and most preferably 0.85 kgf/mm². The annealing furnace entrance tension may be based on the tension applied to the bridle roll. In the 600 to 750 °C range, grain recovery and recrystallization may actively occur, and in the present invention, it may be preferable to minimize the holding time in this range. Accordingly, segregation at the grain boundary may be promoted, thereby improving the texture. When the holding time exceeds 24 seconds, it may be difficult to sufficiently obtain the above-described effect. The holding time may more preferably be 22 seconds or less, and may even more preferably be 20 seconds or less. In the present invention, a shorter holding time may be advantageous, such that there may be no particular limitation on a lower limit thereof. However, a lower limit of the holding time may be, for example, 10 seconds.

### MODE FOR INVENTION

Hereinafter, the present disclosure may be described more specifically through embodiments. However, it should be noted that the embodiments below are merely intended to describe the present disclosure in greater detail based on embodiments, and are not intended to limit the scope of the rights of the present disclosure. This may be because the scope of rights of the present invention is determined by matters described in the claims and matters reasonably inferred therefrom.

### EMBODIMENT

A slab (C, N, Ti: 0.003%) having the alloy composition as in Table 1 below was heated at 1150 °C, the heated slab was finished hot-rolled at 850 °C and a hot-rolled sheet having a thickness of 2.0 mm was obtained. Thereafter, the hot-rolled sheet was annealed at 1100 °C for 4 minutes and was pickled. Thereafter, the hot-rolled sheet was cold-rolled at a reduction ratio of 87.5% and a cold-rolled sheet having a thickness of 0.25 mm was obtained. Thereafter, a final annealing was performed under the conditions listed in Table 2 below, thereby manufacturing a non-oriented electrical steel sheet. The conditions listed in Table 2 below were based on the surface temperature of the steel sheet.

For the non-oriented electrical steel sheet manufactured as above, the texture (112)[1-31] strength and the texture (112)[1-10] strength were measured, and resistivity, iron loss (W10/400) and magnetic flux density (B50) were measured. The results are listed in Table 3 below.

The texture (112)[1-31] strength and the texture (112)[1-10] strength were measured using SEM-EBSD.

Resistivity may be obtained through Equation 1 below.

$$13.25 + 11.3 \times ( [ Si ] + [ Al ] + [ Mn ] / 2 ) \qquad [ Formula 1 ]$$

Iron loss (W10/400) and magnetic flux density (B50) were measured using a single sheet tester in accordance with the JIS standard.

TABLE 1

| | Alloy composition (weight %) | | | | | | |
|---|---|---|---|---|---|---|---|
| Steel type | Si | Al | Mn | Cu | Sn | S | Equation 1 |
| Inventive | 3.3 | 0.8 | 0.3 | 0.03 | 0.01 | 0.002 | 0.067 |
| steel 1 | | | | | | | |
| Comparative | 3.3 | 0.8 | 0.3 | 0.05 | 0.1 | 0.01 | 2.000 |
| steel 1 | | | | | | | |
| Comparative | 3.3 | 1.2 | 0.7 | 0.5 | 0.01 | 0.002 | 0.004 |
| steel 2 | | | | | | | |
| Inventive | 3.3 | 0.9 | 1.5 | 0.06 | 0.03 | 0.0025 | 0.125 |
| steel 2 | | | | | | | |
| Inventive | 4.1 | 0.8 | 0.3 | 0.09 | 0.03 | 0.0025 | 0.083 |
| steel 3 | | | | | | | |
| Inventive | 4.3 | 0.8 | 2 | 0.25 | 0.03 | 0.003 | 0.036 |
| steel 4 | | | | | | | |
| Inventive | 3.3 | 0.8 | 2 | 0.03 | 0.03 | 0.0035 | 0.350 |
| steel 5 | | | | | | | |
| Comparative | 2.7 | 0.5 | 0.3 | 0.06 | 0.03 | 0.004 | 0.200 |
| steel 3 | | | | | | | |
| Inventive | 3.3 | 1.5 | 0.3 | 0.5 | 0.03 | 0.0045 | 0.027 |
| steel 6 | | | | | | | |
| Comparative | 3.3 | 0.8 | 0.3 | 0.06 | 0.005 | 0.005 | 0.042 |
| steel 4 | | | | | | | |
| Comparative | 3.3 | 0.8 | 0.3 | 0.06 | 0.15 | 0.0055 | 1.375 |
| steel 5 | | | | | | | |
| Inventive | 3.4 | 0.8 | 0.3 | 0.06 | 0.03 | 0.006 | 0.300 |
| steel 7 | | | | | | | |
| Inventive | 3.5 | 0.8 | 1 | 0.06 | 0.03 | 0.0065 | 0.325 |
| steel 8 | | | | | | | |
| Comparative | 3.6 | 0.8 | 2.1 | 0.03 | 0.03 | 0.007 | 0.700 |
| steel 6 | | | | | | | |
| Inventive | 3.3 | 1 | 0.3 | 0.5 | 0.03 | 0.0075 | 0.045 |
| steel 9 | | | | | | | |
| Comparative | 3.3 | 1.1 | 0.3 | 0.06 | 0.03 | 0.0015 | 0.075 |
| steel 7 | | | | | | | |
| Comparative | 3.3 | 0.9 | 0.3 | 0.06 | 0.03 | 0.011 | 0.550 |
| steel 8 | | | | | | | |
| Inventive | 3.3 | 1.5 | 0.3 | 0.5 | 0.03 | 0.005 | 0.030 |
| steel 10 | | | | | | | |
| Inventive | 3.6 | 0.8 | 1.1 | 0.07 | 0.03 | 0.005 | 0.214 |
| steel 11 | | | | | | | |
| Comparative | 3.7 | 0.8 | 1.2 | 0.06 | 0.06 | 0.012 | 1.200 |
| steel 9 | | | | | | | |
| Comparative | 3.3 | 1.2 | 0.3 | 0.06 | 0.09 | 0.0018 | 0.270 |
| steel 10 | | | | | | | |
| Comparative | 3.3 | 1.2 | 0.3 | 0.6 | 0.01 | 0.002 | 0.003 |
| steel 11 | | | | | | | |
| Inventive | 3.7 | 1.5 | 1 | 0.08 | 0.1 | 0.002 | 0.250 |
| steel 12 | | | | | | | |
| Inventive | 3.3 | 1.3 | 0.3 | 0.3 | 0.03 | 0.005 | 0.050 |
| steel 13 | | | | | | | |

$$Sn \times S \times 100 / Cu \qquad [ Equation 1 ]$$

TABLE 2

| | | Final annealing | | | |
|---|---|---|---|---|---|
| | | Annealing | Holding | | |
| | | furnace | time in | Cracking | Crack- |
| | | entrance | 600 to | temper- | ing |
| | | tension | 750 °C | ature | time |
| Classification | Steel type | (fg/mm²) | (sec) | (°C) | (sec) |
| Inventive | Inventive | 0.65 | 18 | 1000 | 38 |
| example 1 | steel 1 | | | | |
| Comparative | Comparative | 0.63 | 15 | 980 | 42 |
| example 1 | steel 1 | | | | |
| Comparative | Comparative | 0.76 | 13 | 990 | 40 |
| example 2 | steel 2 | | | | |
| Inventive | Inventive | 0.83 | 17 | 1000 | 55 |
| example 2 | steel 2 | | | | |
| Comparative | Inventive | 0.58 | 25 | 995 | 58 |
| example 3 | steel 3 | | | | |
| Comparative | Inventive | 0.34 | 15 | 965 | 59 |
| example 4 | steel 4 | | | | |
| Inventive | Inventive | 0.51 | 22 | 975 | 57 |
| example 3 | steel 5 | | | | |
| Comparative | Comparative | 0.78 | 16 | 980 | 52 |
| example 5 | steel 3 | | | | |
| Inventive | Inventive | 0.88 | 15 | 985 | 48 |
| example 4 | steel 6 | | | | |
| Comparative | Comparative | 1.05 | 17 | 985 | 47 |
| example 6 | steel 4 | | | | |
| Comparative | Comparative | 0.55 | 14 | 995 | 43 |
| example 7 | steel 5 | | | | |
| Inventive | Inventive | 0.66 | 22 | 1005 | 35 |
| example 5 | steel 7 | | | | |
| Inventive | Inventive | 0.58 | 12 | 1005 | 38 |
| example 6 | steel 8 | | | | |
| Comparative | Comparative | 0.69 | 18 | 980 | 54 |
| example 8 | steel 6 | | | | |
| Inventive | Inventive | 0.71 | 16 | 1010 | 37 |
| example 7 | steel 9 | | | | |
| Comparative | Comparative | 0.62 | 22 | 1020 | 32 |
| example 9 | steel 7 | | | | |
| Comparative | Comparative | 0.58 | 21 | 980 | 48 |
| example 10 | steel 8 | | | | |
| Inventive | Inventive | 0.78 | 17 | 965 | 58 |
| example 8 | steel 10 | | | | |
| Inventive | Inventive | 0.69 | 15 | 985 | 57 |
| example 9 | steel 11 | | | | |
| Comparative | Comparative | 0.88 | 12 | 985 | 54 |
| example 11 | steel 9 | | | | |
| Comparative | Comparative | 0.95 | 11 | 990 | 51 |
| example 12 | steel 10 | | | | |
| Comparative | Comparative | 0.88 | 19 | 990 | 48 |
| example 13 | steel 11 | | | | |
| Inventive | Inventive | 0.57 | 20 | 995 | 53 |
| example 10 | steel 12 | | | | |
| Inventive | Inventive | 0.54 | 23 | 975 | 59 |
| example 11 | steel 13 | | | | |

TABLE 3

| | Texture | Texture | | | Iron | Magnetic flux |
|---|---|---|---|---|---|---|
| | (112)[1-31] | (112)[1-10] | Strength | Resistivity | loss(W10/400) | density (B50) |
| Classification | strength | strength | ratio | (μΩcm) | (W/Kg) | (Tesla) |
| Inventive | 3.2 | 0.6 | 5.3 | 61 | 11.5 | 1.67 |
| example 1 | | | | | | |
| Comparative | 2.2 | 1.2 | 1.8 | 61 | 12.8 | 1.65 |
| example 1 | | | | | | |
| Comparative | 1.5 | 1.3 | 1.2 | 68 | 12.4 | 1.63 |
| example 2 | | | | | | |
| Inventive | 3.1 | 0.7 | 4.4 | 69 | 11.2 | 1.66 |
| example 2 | | | | | | |
| Comparative | 2.1 | 1.5 | 1.4 | 70 | 12.4 | 1.62 |
| example 3 | | | | | | |
| Comparative | 1.9 | 1.1 | 1.7 | 82 | 12.3 | 1.60 |
| example 4 | | | | | | |
| Inventive | 3.4 | 0.7 | 4.9 | 71 | 11.3 | 1.66 |
| example 3 | | | | | | |
| Comparative | 1.7 | 1.2 | 1.4 | 51 | 13.2 | 1.65 |
| example 5 | | | | | | |
| Inventive | 3.5 | 0.7 | 5.0 | 69 | 11.4 | 1.66 |
| example 4 | | | | | | |
| Comparative | 1.8 | 1.1 | 1.6 | 61 | 12.7 | 1.65 |
| example 6 | | | | | | |
| Comparative | 2.1 | 1.7 | 1.2 | 61 | 12.8 | 1.64 |
| example 7 | | | | | | |
| Inventive | 3.7 | 0.7 | 5.3 | 62 | 11.5 | 1.68 |
| example 5 | | | | | | |
| Inventive | 3.9 | 0.6 | 6.5 | 67 | 11.8 | 1.67 |
| example 6 | | | | | | |
| Comparative | 1.8 | 1.2 | 1.5 | 69 | 12.5 | 1.63 |
| example 8 | | | | | | |
| Inventive | 2.7 | 0.7 | 3.9 | 64 | 11.3 | 1.67 |
| example 7 | | | | | | |
| Comparative | 2.4 | 1.6 | 1.5 | 65 | 12.7 | 1.64 |
| example 9 | | | | | | |
| Comparative | 2.1 | 1.4 | 1.5 | 62 | 13.2 | 1.63 |
| example 10 | | | | | | |
| Inventive | 4.5 | 0.4 | 11.3 | 69 | 11.2 | 1.67 |
| example 8 | | | | | | |
| Inventive | 4.2 | 0.6 | 7.0 | 69 | 11.1 | 1.66 |
| example 9 | | | | | | |
| Comparative | 2.1 | 1.1 | 1.9 | 71 | 12.7 | 1.62 |
| example 11 | | | | | | |
| Comparative | 1.7 | 1.4 | 1.2 | 66 | 12.9 | 1.63 |
| example 12 | | | | | | |
| Comparative | 1.8 | 1.2 | 1.5 | 66 | 13.1 | 1.62 |
| example 13 | | | | | | |
| Inventive | 3.8 | 0.7 | 5.4 | 78 | 11.4 | 1.66 |
| example 10 | | | | | | |
| Inventive | 3.5 | 0.5 | 7.0 | 67 | 11.7 | 1.67 |
| example 11 | | | | | | |

As indicated in Tables 1 to 3, in inventive examples 1 to 11 satisfying the alloy composition and manufacturing conditions suggested in the present invention, by satisfying the texture (112)[1-31]/texture (112)[1-10] strength ratio suggested in the present invention, the low high frequency iron loss was assured.

In comparative examples 1 to 13, which did not satisfy the alloy composition or manufacturing conditions suggested in the present invention, as the texture (112)[1-31]/texture (112)[1-10] strength ratio suggested by the present invention were not satisfied, the high frequency iron loss became worse.

The embodiments of the present disclosure has been described, but the scope of the present disclosure is not limited to the embodiments above, and other modifications based on the present disclosure may be made by those skilled in the art within the technical scope above.

1. A non-oriented electrical steel sheet, comprising:
by weight %, Si: 3.3 to 4.3%, Al: 0.8 to 1.7%, Mn: 0.3 to 2.0%, Cu: 0.03 to 0.5%, Sn: 0.01 to 0.1%, S: 0.002 to 0.01%, and a balance of Fe and inevitable impurities,
wherein relational expression 1 is satisfied, and
wherein texture (112)[1-31]/texture (112)[1-10] strength ratio is 2.0 or more:
$$0.02 \leq Sn \times S \times 100 / Cu \leq 0.75 . \qquad [ Relational expression 1 ]$$

2. The non-oriented electrical steel sheet of claim 1, wherein the non-oriented electrical steel sheet further includes one or more of C: 0.005% or less, N: 0.005% or less, Ti: 0.005% or less, Nb: 0.005% or less and V: 0.005% or less.

3. The non-oriented electrical steel sheet of claim 1, wherein the non-oriented electrical steel sheet further includes one or more of P: 0.1% or less, Cr: 0.01 to 0.5%, Sb: 0.1% or less, Ni: 0.05% or less and Zn: 0.01% or less.

4. The non-oriented electrical steel sheet of claim 1, wherein the non-oriented electrical steel sheet further includes one or more of Mo: 0.03% or less, B: 0.0050% or less, Ca: 0.005% or less and Mg: 0.005% or less.

5. The non-oriented electrical steel sheet of claim 1, wherein the non-oriented electrical steel sheet further includes 0.20% or less (excluding 0%) of one or more of Bi, Pb, Ge and As individually or in combination.

6. The non-oriented electrical steel sheet of claim 1, wherein a strength of texture (112)[1-31] of the non-oriented electrical steel sheet is 2.5 or more and a strength of texture (112)[1-10] is 0.9 or less.

7. The non-oriented electrical steel sheet of claim 1, wherein the non-oriented electrical steel sheet has a resistivity of 55 μΩcm or more.

8. The non-oriented electrical steel sheet of claim 1, wherein the non-oriented electrical steel sheet has iron loss (W10/400) of 12.2 W/Kg or less.

9. The non-oriented electrical steel sheet of claim 1, wherein the non-oriented electrical steel sheet has a magnetic flux density (B50) of 1.66 Tesla or more.

10. A method for manufacturing a non-oriented electrical steel sheet, the method comprising:
heating a slab including, by weight %, Si: 3.3 to 4.3%, Al: 0.8 to 1.7%, Mn: 0.3 to 2.0%, Cu: 0.03 to 0.5%, Sn: 0.01 to 0.1%, S: 0.002 to 0.01%, and a balance of Fe and inevitable impurities, and satisfying relational expression 1 as below at 1100 to 1250 °C;
finishing hot-rolling the heated slab at 800 to 1000 °C and obtaining a hot-rolled sheet;
cold-rolling the hot-rolled sheet at a reduction ratio of 70 to 95% and obtaining a cold-rolled sheet;
final annealing for cracking the cold-rolled sheet at 950 to 1020 °C for 30 to 60 seconds,
wherein, in the final annealing, entrance tension of an annealing furnace is 0.5 to 0.5 to 1.0 kgf/mm², and a holding time in a 600 to 750 °C section during heating to a cracking temperature is controlled to 24 seconds or less:
$$0.02 \leq Sn \times S \times 100 / Cu \leq 0.75 \qquad [ Relational expression 1 ]$$

11. The method of claim 10, wherein the slab further includes one or more of C: 0.005% or less, N: 0.005% or less, Ti: 0.005% or less, Nb: 0.005% or less and V: 0.005% or less.

12. The method of claim 10, wherein the slab further includes one or more of P: 0.10% or less, Cr: 0.01 to 0.5%, Sb: 0.1% or less, Ni: 0.05% or less and Zn: 0.01% or less.

13. The method of claim 10, wherein the slab further includes one or more of Mo: 0.03% or less, B: 0.0050% or less, Ca: 0.005% or less and Mg: 0.005% or less.

14. The method of claim 10, wherein the slab further includes 0.20% or less (excluding 0%) of one or more of Bi, Pb, Ge and As individually or in combination.

15. The method of claim 10, wherein the method further includes hot-rolled sheet annealing the hot-rolled sheet at 850 to 1150 °C after the obtaining the hot-rolled sheet.

16. The method of claim 10, wherein the cold-rolling is performed once or twice.
